(19) United States
(12) Patent Application Publication
(10) Pub. No.: US 2024/0012630 A1
(43) Pub. Date: Jan. 11, 2024

(54) AUTOMATED PLATFORM FOR MANAGING, DEPLOYING AND ORCHESTRATING HIGHLY DISTRIBUTED SERVICE APPLICATIONS

(71) Applicants: Xeniro, Shanghai (CN); Xeniro (Taiwan) Limited, Taipei (TW)

(72) Inventors: En Shen Huang, Shanghai (CN); Kang-Huan Peng, Taipei (TW)

(73) Assignees: Xeniro, Shanghai (CN); Xeniro (Taiwan) Limited, Taipei (TW)

(21) Appl. No.: 18/038,617

(22) PCT Filed: Dec. 18, 2020
(86) PCT No.: PCT/CN2020/137755

§ 371 Date: May 24, 2023

(51) Int. Cl. G06F 8/61

(52) U.S. Cl. CPC G06F 8/61

(57) ABSTRACT

A platform for creating a file specifying parameters required to deploy an application, the platform configured to: receive input for fields present in a deployment file for an application, the input fields imposing constraints on a node where the application can be deployed; interrogate a database storing information on nodes available to deploy the application; identify, from the database, the nodes with operation parameters that comply with the imposed constraints; display, through an interface, one or more layouts for selection, each layout providing a possible combination of the identified nodes to deploy the application; and generate the deployment file based on the selected layout.

### FIELD

Herein disclosed is a platform that facilitates the generation of a file to deploy an application over, for example, a distributed network.

### BACKGROUND

Conflicts may arise when running multiple applications within a same server or within multiple servers and chances are, you face conflicts while running applications, especially when the applications use different runtime environment versions.

To address such version conflicts, each application may be packaged inside a container or a virtual machine. This eliminates version conflicts because the applications are then isolated, with each being bundled with their respective runtime environment libraries.

However, deploying containers or virtual machines across distributed networks is tedious and repetitive work. This is because a deployment file used has to provide information about the nodes on which the containers or virtual machines are deployed. Taking container-based software deployment as an example, numerous steps have to be taken and numerous parameters defined to start a container orchestration cluster on which the application runs.

The provision of such information then becomes impractical when scaled to the large number of nodes that are present in a distributed network. Such complicated and cumbersome operations need to be addressed in light of edge computing gaining traction which sees the use of thousands of micro data centres and a commensurate use of containers.

The present invention seeks to provide a means to facilitate the creation of a deployment file that addresses the above shortcomings, with the deployment file being created in an intuitive manner.

### SUMMARY OF THE INVENTION

According to a first aspect of the invention, there is provided a platform for creating a file specifying parameters required to deploy an application, the platform configured to: receive input for fields present in a deployment file for an application, the input fields imposing constraints on a node where the application can be deployed; interrogate a database storing information on nodes available to deploy the application; identify, from the database, the nodes with operation parameters that comply with the imposed constraints; display, through an interface, one or more layouts for selection, each layout providing a possible combination of the identified nodes to deploy the application; and generate the deployment file based on the selected layout.

### BRIEF DESCRIPTION OF THE DRAWINGS

Representative embodiments of the present invention are herein described, by way of example only, with reference to the accompanying drawings, wherein:

FIG. 1 shows a schematic of a system having a platform for creating a file specifying parameters required to deploy an application over a distributed network.

FIG. 2 shows a flowchart that the platform of FIG. 1 uses to obtain a deployment file.

FIGS. 3A to 3E show a flowchart to create a new deployment file, as facilitated by the platform of FIG. 1.

FIG. 4 shows a flowchart to import a deployment file.

FIG. 5 shows a flowchart to launch a deployment file.

FIG. 6 shows a flowchart that the platform of FIG. 1 follows when maintaining operation of the deployment file.

FIG. 7 shows a schematic of the application that the deployment file generated by the platform of FIG. 1 seeks to deploy over a distributed network.

### DETAILED DESCRIPTION

In the following description, various embodiments are described with reference to the drawings, where like reference characters generally refer to the same parts throughout the different views.

The present invention, in a broad overview, relates to application deployment. Application refers to a computer program that performs a specific function or to meet a certain need, with the present invention directed at ensuring that a host on which the application is deployed meets certain criteria. To this end, the invention provides a platform that can generate a configuration file specifying operation parameters required of a node on which an application is to be deployed. The configuration file, also called a deployment file, specifies the modules running in any one or more of containers, virtual machines, bare metal environments and executable binary files; their connections; module parameters; or trace instructions to configure at application start time. The deployment file provides installation details to a controller responsible for deploying the application on, for example, hyperscale distributed networks. Hyperscale computing allows the scaling of cloud, big data and computing services that is associated with infrastructure necessary to run a densely distributed networks, whereby the platform provides for the execution of an intelligent calculative methodology that orchestrates and manages resources (such as processor, memory and storage) to achieve a specific service requirement.

In an edge computing scenario, a mobile network operator (MNO) may manage any number of network nodes, such as from tens of thousands to hundreds of thousands. Deploying an application in such a network requires describing information for each of these nodes, which is tedious. The platform of the present application seeks to provide a tool to facilitate the creation of deployable files more intuitively and quickly, especially for networks with many nodes.

The platform disclosed herein facilitates deployment file generation by receiving input fields present in the deployment file, the input fields imposing constraints on a node where the application can be deployed, thereby establishing deployment criteria. “Constraints” refer to minimum operation parameters that the node hosting the application should possess and examples include distance between adjacent nodes, minimum processing capability allocated in the node to run the application and location of the node. As such, these input fields received by the platform serve to filter nodes that do not meet deployment requirements. The input fields are extracted from selections made in a menu used to facilitate creation of the deployment file, the content of the menu depending on particulars (such as physical location) and resources (hardware and software parameters) of a network to which the nodes where the application is to be deployed belongs, with the platform having management access over application deployment across the network. The menu thereby provides an input interface that allows the constraints to be set in an intuitive manner.

A node refers to a device in a computer network with client, server or peer capability. As such the node can host applications and receive, process, store and transmit data with any other nodes that pertains to the hosted application. The platform has access to one or more databases that store information on such nodes available to deploy the application. Such information is not limited to parameters indicative of computing processing capability of the nodes, but also includes other data related to a region in which the node is situated, such as physical location data, territorial borders, radio base station sites, military base locations, airport locations, heavy industrial locations, oil rig locations, energy turbine locations, local regulation requirement data, transport infrastructure data, population data, economic data and node service provider resource data. These one or more databases are interrogated to identify nodes with operation parameters that comply with the imposed constraints, i.e. the databases are queried with a search string to locate nodes that can meet or exceed the demands set by the input fields received by the platform for the deployment file.

The identified nodes that comply with the imposed constraints are then organised to be presented for selection. This organisation results in the platform displaying, through an interface, one or more layouts for selection, with each layout providing a possible combination of the identified nodes to deploy the application. Each layout thus sets out an arrangement of nodes which meets the deployment requirements defined by the imposed constraints, while allowing the application to still perform its function (e.g. to support electronic wallet payment along a highway). In the scenario where the interface is a map, each map shows the location of the nodes for one identified arrangement at a geographic area, so that several maps may be used if the platform identifies more than one arrangement of nodes that meet the requirements of the deployment file. The interface for the layout can thus be considered as an output interface, in contrast to the input interface that receives the constraints for the deployment file. Finally, the platform generates the deployment file based on the selected layout.

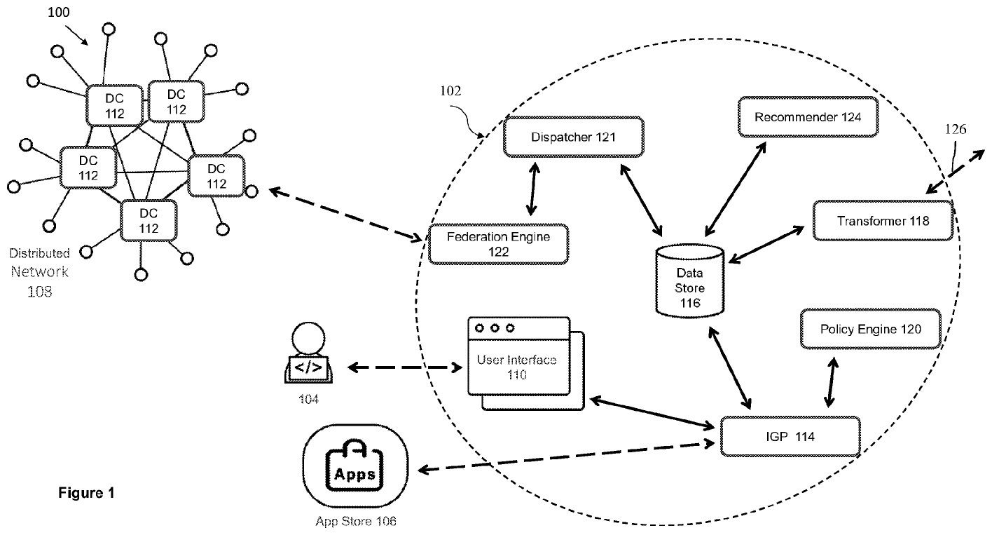

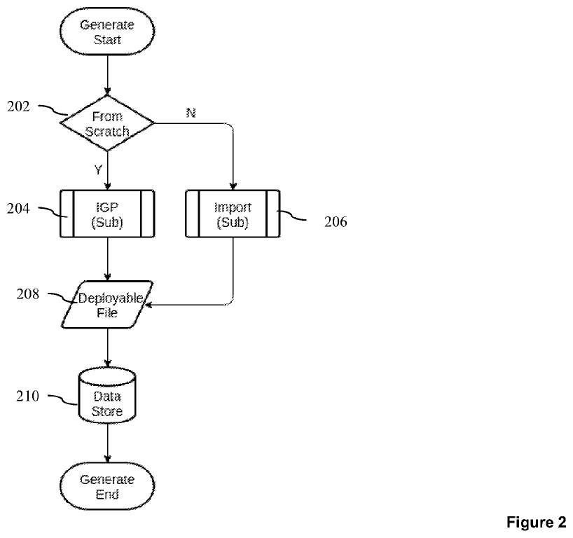

The operation of the platform is described in greater detail with reference to the flowcharts of FIGS. 1 to 6.

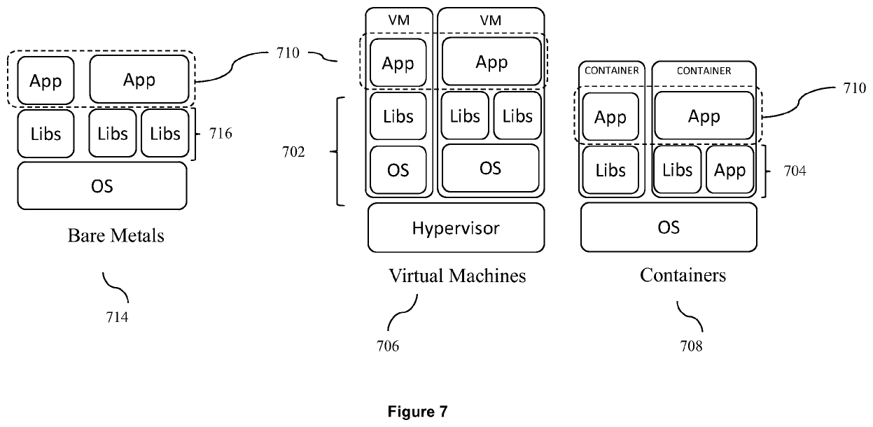

FIG. 1 shows a schematic of a system 100 in which a platform 102 in accordance with the present invention operates, the platform 102 for creating a file specifying parameters required to deploy an application. This file is hereafter referred to as “a deployment file”. The platform 102 may be implemented through microservices, i.e. on a single computer or over several computers, such as a cloud network. The platform has several components, which are described in greater detail below with reference to a user 104 wanting to deploy an application from an application repository 106 onto a distributed network 108. In one implementation, the application is bundled with a software stack of dependencies such as necessary executables, binary code, runtime environment variables and libraries (see FIG. 7, with the stack denoted using reference numerals 702 and 704), to constitute either a virtual machine package or a container package, depending on the exact files in the stack. The deployment file created by the platform 102 serves to describe the configuration of the application, such as how to establish networking, how to mount storage volumes and where to store logs. With the platform 102 allowing the fields of the deployment file to be determined, the platform 102 therefore provides an orchestration tool that sets the minimum infrastructure for the application package, such as the amount of compute, network, and storage resources required.

A user interface 110 allows the user 104 access to the platform 102. The user interface 110 receives input for fields present in the deployment file that is to be executed over the distributed network 108, the input fields imposing constraints on a node 112 where the application can be deployed. In one implementation, the user interface 110 provides a menu whose content depends on the particulars (such as physical location) and resources (hardware and software parameters) of the distributed network 108, with the presentation of content being managed by an interactive guided process (IGP) module 114. The IGP module 114 serves to assist the user 104 to deploy the application from the repository 106 by presenting the menu content in a user friendly intuitive layout, thereby easing the selection of the content The selected content in the menu become the input fields in the deployment file that impose the constraints on the node 112 where the application can be deployed.

The database 116 stores data that is required for the application deployment, such as information associated with the nodes 112 of the distributed network 108. Such information includes, but is not limited to, physical location data of the nodes 112, local regulation requirement data (i.e. regulations for the location in which the nodes 112 are located), transport infrastructure data, population data, economic data and node service provider resource data (i.e. data on the providers to which the nodes 112 belong). A data transformer module 118 obtains 126 such information from external sources and converts it into a format that can be processed by the platform 102. It will also be appreciated that the database 116 may also store other data that is not used for application deployment.

The IGP module 114 interrogates the database 116 to identify the nodes 112 with operation parameters that comply with the imposed constraints received, by the user interface 110 through the above mentioned menu. The IGP module 114 works in conjunction with a policy engine 120 to interrogate the database 116, as the policy engine 120 provides the algorithms that perform the calculations to find the nodes 112 that match the imposed constraints.

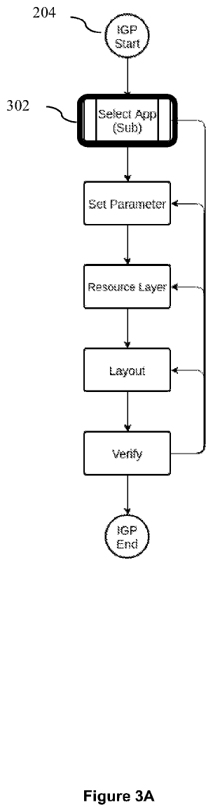

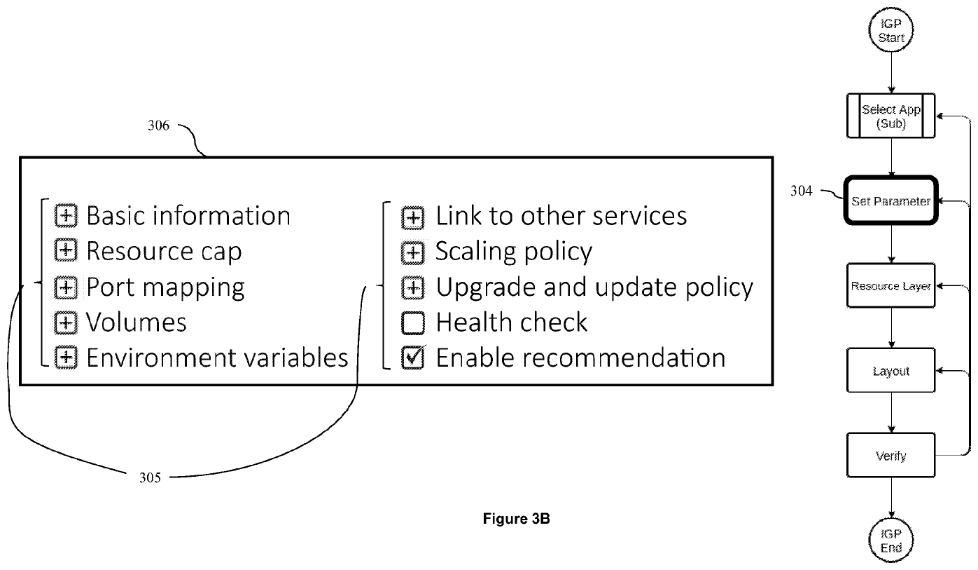

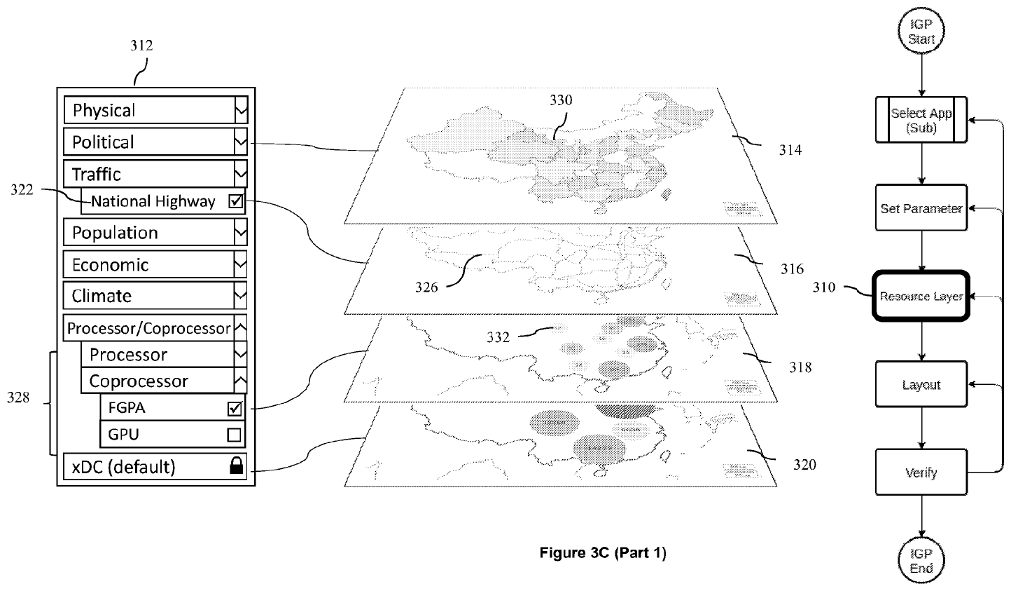

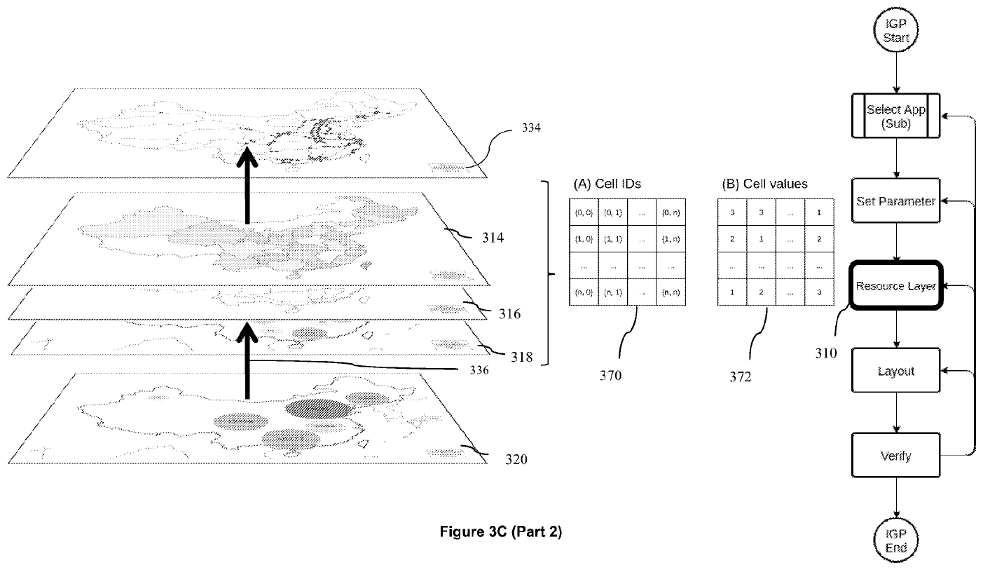

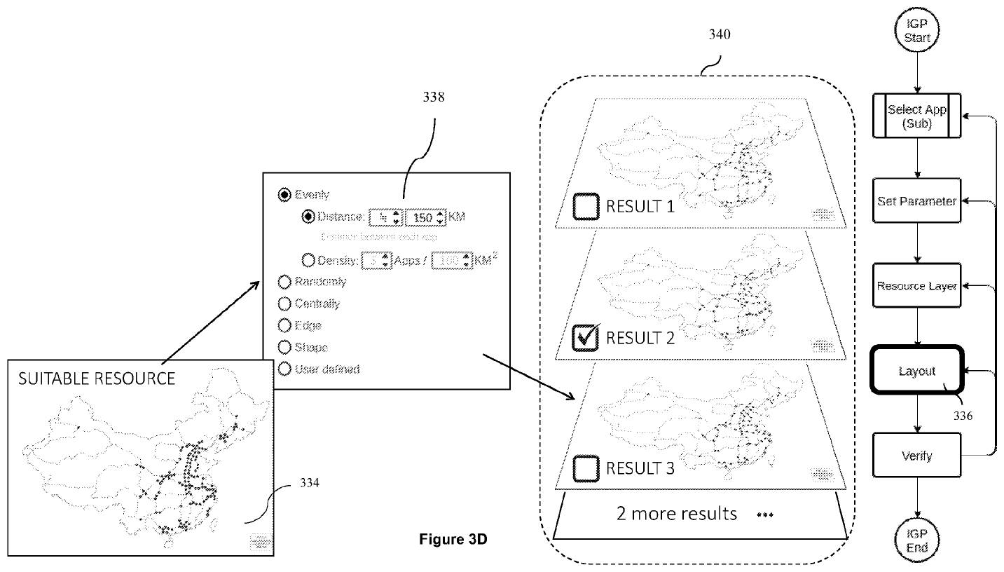

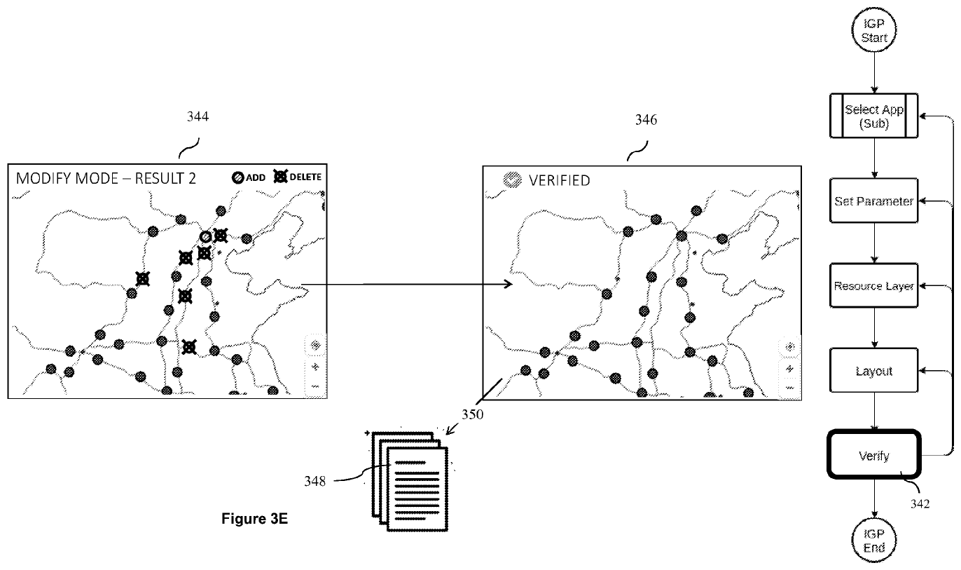

In one implementation, the policy engine 120 is responsible for formulating one or more search strings, each based on the imposed constraints received by the user interface 110, for interrogating the database 116. With reference to FIGS. 3B to 3D, the imposed constraints are received in two stages, where a first stage sees constraints received at steps 304 (set parameters) and 310 (resource layer); and a second stage sees constraints received at step 336 (layout). The constraints received in the first stage results in the IGP module 114 showing all available nodes that can be used in the distributed network, output in a resource layer 334 (see FIG. 3C (Part 2)). At the step 336, filtering conditions 338 can be imposed on the nodes of the resource layer 334 that results in the display of one or more layouts, each layout providing a possible combination of the identified nodes 112 to deploy the application. The selected layout becomes the constraints received in the second stage.

As an example, a first stage of constraints imposes deployment requirements at the steps 304 and 310 that return six possible points A to F to deploy an application across a region. For the sake of simplicity, the six possible points lie on a straight line, with each point being 50 km apart.

At the step 336, if the application is set to be deployed at all six points, this results in having no constraints received in the second stage. On the other hand, if the application is to be deployed at only two points, conditions that the two points must meet have to be set out in the step 336. For instance, the condition may be that the two points must be around 100 km. The policy engine 120 will calculate the feedback based on the given condition and returns the following deployment possibilities: (A, C), (B, D), (C, E) and (D, F). The IGP module 114 displays these four possible layouts for selection. The selected layout then forms the second stage of constraints. Steps 304, 310 and 336 are described in more detail below with respect to FIGS. 3B to 3D.

Returning to FIG. 1, the user interface 110, the IGP module 114, the policy engine 120, the data transformer module 118 and the database 116 thus allow the user 104 to generate deployment files for storage into the database 116. The deployment files are in a format recognised by a dispatcher module 121 and a federation engine 122. The user 104 can retrieve any stored deployment file from the database 116 for modification when needed. The changes can be applied across the distributed network 108 by executing the modified deployment file.

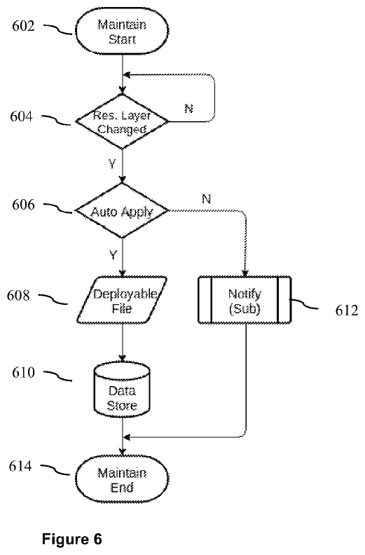

When the user 104 decides to execute a stored deployment file, a dispatcher module 121 will feed the deployment file from the database 116 into a federation engine module 122 for launching over the distributed network 108. A recommender module 124 monitors the distributed network 108 for resource changes in the nodes 112 or receipt of external data from the data transformer module 118 and their impact on the deployed applications. If there are better options for the user 104, such as a better layout of the nodes 112, lower cost of resources or newly released computing acceleration hardware, notifications and recommendations will be sent to the user 104. The operation of the recommender module 124 is described in greater detail with reference to the flowchart of FIG. 6.

The database 116, the dispatcher module 121 and the federation engine module 122 thus allow the user 104 to execute the generated deployment files to deploy its associated application to the distributed network 108. If the user 104 is concerned whether there are sufficient resources in the distributed network 108, a simulated execution of the deployment file can be performed, so as to measure performance results of the layout of the nodes 112 on which the deployment file was generated. The user 104 can apply rolling updates and rollbacks to a part (e.g. city/province/region) or the entire distributed network 108 while the deployed applications are running.

Each of FIGS. 2 to 6 show a flowchart for different stages of operation of the platform 102.

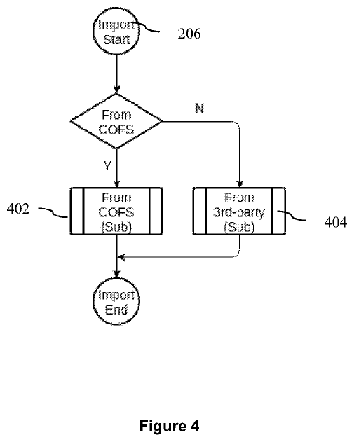

FIG. 2 shows a flowchart to obtain a deployment file. At step 202, the user 104 is prompted to choose how a deployment file is to be obtained. Step 204 occurs if the user 104 selects to make the deployment file from scratch, i.e. a new deployment file is created. This is described in greater detail in FIGS. 3A to 3E. Step 206 occurs if the user 104 selects to import a deployment file, which is described in greater detail in FIG. 4. The deployment file is output in step 208 and stored in the database 116 in step 210.

FIGS. 3A to 3E show a flowchart to create a new deployment file, which is facilitated by the IGP module 104.

This flowchart adopts a sequential processing approach. Each step is completed before the next step can be initiated, whereby the result of a first step (such as 304) will be the basis of the second step (310), and the result of the second step will be the basis of the third step (336). Each step of the flowchart, especially those of 304, 310 and 336, involves the selection of resource parameters that become the input fields that impose the constraints on the node where an application can be deployed. The resource parameters are organised by category, with the categories being further organised into hierarchical levels accessible according to sequence. The resource parameters at the step 304 belong to the highest hierarchy for requiring to be configured first before access to the next hierarchy, resource parameters, at the step 310 is allowed. The resource parameters that are available at the step 310 is the result of imposed constraints by the step 304. As such, the sequential processing approach of FIGS. 3A to 3E gradually narrows the options available as creation of the deployment file progresses.

The flowchart starts from the step 204, which is already described in FIG. 2 above. At step 302, an application which is to be deployed is received. This application may be obtained from the repository 106, as explained above with reference to FIG. 1.

At step 304 (see FIG. 3B) the user 104 is invited to begin setting parameters of the deployment file for the application of step 302.

The IGP module 114 facilitates by first presenting to the user 104 a menu 306 providing fields 305 to enter basic operation parameters required of a node on which an application for the application to be deployed. These fields 305 may be specific to the application being deployed and are therefore not limited to those shown in FIG. 3B, namely basic information, link to other services, resource cap, scaling policy, port mapping, upgrade and update policy, volumes and environment variables. Basic information allows naming of the application that is to be deployed and the URL of the application repository to be entered. Link to other services caters for scenarios when the application to be deployed depends on other applications. For example, if there is a need for the application to be deployed to connect to a separate database, details for the separate database may be entered in the link to other services. Resource cap allows for limitations of CPU, RAM, storage capacity and network bandwidth to be entered. Scaling policy allows for setting out of conditions under which the application to be deployed can be scaled, for example when there is >80% of CPU utilisation on average. The scaling policy can also be used to specify the total number of applications to be deployed, such as 10. Port mapping allows configuration of fixed network ports used by the application to be deployed. Upgrade and update policy allows for stipulation of the frequency to check for the latest version of an application to be deployed, where to check for the latest version and actions to be taken if there is a new version. Volumes allow for storage capacity, the level of disk needed and how much disk space is needed to be entered. Environment variables allow for system parameters like timezone and the maximum number of TCP/IP connections to be entered. Health check is to specify whether a heartbeat service, where the platform 102 checks whether the application to be deployed is alive, is to be activated. When the enable recommendation field is checked, the recommender module 124 will monitor the distributed network 108 for resource changes in the nodes 112 after the deployment file is executed. Although not shown, the menu 306 can also list available resource parameters (e.g. allocation of minimum processing capability to run the application) of the distributed network 108, which when selected become constraints on the node 112 where the application of the step 302 can be deployed.

After the parameters in the step 304 are set, the next sequence is to select resource parameters in step 310 (see FIG. 3C (Part 1)). The resource parameters 312 are organised in layers 314, 316, 318 and 320, each layer for a category under which one or more fields 322, 328 for related resource parameters are organised. Access to the one or more of these fields 322, 328 under their respective organised category is through one or more of: a pull down list, a rollover list, a list contained in a pop-up window, or a list in a new window. For the sake of simplicity, only a pull down list is shown in FIG. 3C (Part 1).

The resource parameters 312 are organised under the following categories: physical, political, traffic, population, economic, climate, processor and default. The default category has information in its corresponding resource layer 320 on all nodes that the platform 102 has management access to deploy applications. That is, layer 320 shows all available resources within the territory of a service provider. This graphic representation of data (a.k.a data visualization) is generated by the data transformer module 118 (refer FIG. 1). As such, the layer 320 can be thought of as a base layer. For the sake of simplicity, the only other categories that are discussed are the political, traffic and processor categories in the context of two scenarios.

Resource parameters belonging to the traffic category are used in a first scenario for applications relating to fleet management, where services are to be deployed along a highway. The traffic category has a field 322 that retrieves highway routes 326 stored in its corresponding resource layer 316. While not shown, the IGP module 104 will then superimpose nodes that are in proximity to the retrieved highway routes 326, ensuring that the superimposed nodes meet other constraints set by the user 104.

Resource parameters belonging to the processor and the political categories are used in a second scenario of deploying applications that require FPGA (field programmable gate array) processing capability in selected provinces. The political category will retrieve provincial boundaries 330 of an area where the applications are to be deployed from its corresponding resource layer 314, while the processor category has fields 328 that allow the user to access information on the location of nodes with FPGA processing capability stored in its corresponding resource layer 318. While not shown, the IGP module 104 will then return a layout that superimposes the nodes with FPGA capability on the provinces which require FPGA processing capability.

The above two scenarios establish that menu content representing resource parameters impose constraints on the node where the application can be deployed when they are selected. In addition, the first scenario eliminates nodes not in proximity to the retrieved highway routes 326 are eliminated, while the second scenario eliminates nodes that do not have FPGA processing capability. As such, the IGP module 104 determines whether the choice of resource parameters in an earlier selection has an impact on resource parameters available for subsequent selection and updates the content of the menu to remove the resource parameters that have become unavailable for the subsequent selection.

Turning to FIG. 3C (Part 2), the layers 314, 316 and 318 act like filters which are laid (symbolised by the arrow 336) on top of the base layer 320. These filters assist the user 104 to choose available resource parameters that lead up to achieving deploying their application in accordance with all imposed constraints (see FIG. 3D which details another possible filter). After the user 104 has selected all the required resource parameters, the policy engine 120 will derive a suitable resource layer 334 that captures all the nodes that comply with the imposed constraints defined by the user 104 up to this point.

In one approach, the filtering performed at the layers 314, 316 and 318 is achieved by use of mathematical operations that process whether an attribute represented by a look-up value corresponding to an overlapped co-ordinate meets criteria that is determined by the selected resource parameters 312 in the step 310. The nodes identified in the resource layer 334 are those located at co-ordinates with look-up values that meet the criteria, the identified nodes being usable to deploy the application. Under this approach, each resource layer 314, 316 and 318 is treated as a n-by-n co-ordinate matrix 370, i.e. a matrix with n rows and n columns. Since the matrices for each of the layer 314, 316 and 318 have the same order, they can be overlapped. Each of the n×n cells is assigned a value in a corresponding look-up table 372, with each value representing an attribute. For example, in a layer (not shown) for the physical category “1” represents mountains and “2” represents rivers.

The attribute represented by each value in the look-up table 372 depends on the layer 314, 316 and 318 to which it is associated. As such each look-up value has a different meaning, e.g. the look-up value for the co-ordinate (0, 1) in a layer (not shown) for the population category represents a size range of the population within that co-ordinate, while the look-up value for the same co-ordinate (0, 1) in the layer 138 for the processor category represents the availability of computing nodes within that co-ordinate.

Table 1 below provides a sample algorithm and the mathematical operations used to overlap the layers 314, 316 and 318 that allow the identification of nodes in the resource layer 334.

TABLE 1
Sample algorithm to overlap resource layers

| | |
|---|---|
| 1 | let layer1, layer2, result are arr[n][ [symbol] ] |
| 2 | |
| 3 | function Overlay(layer1, layer2) result { |
| 4 | for i (0 to n-1) do |
| 5 | for j (0 to n-1) do |
| 6 | if layer1[i][j] AND layer2[i][j] == [the cell value of mountain] then |
| 7 | result[i][j] = true |
| 8 | end if |
| 9 | return result |
| 10 | } |

[symbol]

indicates data missing or illegible when filed

Turning to FIG. 3D, the layout of the nodes in the suitable resource layer 334 may be changed at step 336 according to one or more conditions 338 specified by the user 104. These conditions 338 can also act as a further filter to those described in FIG. 3C (Parts 1 and 2), forming part of the constraints that the node has to meet for application deployment which can eliminate several of the nodes present in the suitable resource layer 334. If the applied conditions 338 result in multiple layouts 340, with each providing a possible combination of nodes to deploy the application, the user 104 is prompted to select one.

The condition 338 that is illustrated in FIG. 3D relates to specifying a minimum distance between nodes on which an application is to be deployed. In one approach, an approximation algorithm (see Table 2 below) that solves a “set cover problem” (a classical question in combinatorics, computer science, operations research, and complexity theory) is adopted to solve for this minimum distance.

TABLE 2
Approximation algorithm used to solve for minimum
distance between nodes

```
Input:
  Ground elements, or Universe U = {u₁, u₂, . . . ,uₙ}
  Subsets S₁,S₂, . . . , Sₖ ⊆ U
  Costs c₁, c₂, . . . , cₖ
Goal:
  Find a set I ⊆ {1, 2, . . . , m} that minimizes ${\sum }_{i ∈ I} {c}_{i} , such that {⋃}_{i ∈ I} {S}_{i} = U .$
(note: in the un-weighted Set Cover Problem, cⱼ = 1 for all j)
```

The use of a geographic map, as shown in FIG. 3D, over which the one or more layouts for selection are superimposed is advantageous in that it helps the user 104 to visualise the possible combination of nodes to deploy the application. The ability to select the layout through the geographic map and modify the layout (as part of verification that occurs in step 342, see FIG. 3E below) allows for the user 104 to more intuitively arrive at a desired node layout.

Verification of the selected layout 344 from the step 342 occurs in step 342, which is described with reference to FIG. 3E. The IGP module 114 provides a graphic tool to modify the selected layout 344, for example by adding and removing nodes to the satisfaction of the user 104. A deployment file 348 can then be generated 350 from the verified layout 346 by the data transformer module 118. The deployment file 348 is in a format that is recognised by the dispatcher module 121 and the federation engine 122.

FIG. 4 shows a flowchart if the user 104 selects to import a deployment file, as opposed to creating a new deployment file. The flowchart starts from the step 206 described in FIG. 2. Step 402 occurs if the deployment file is stored in the platform 102, where it is retrieved from the database 116. Step 404 occurs if the deployment file is imported from an external source, which is performed by the data transformer module 118.

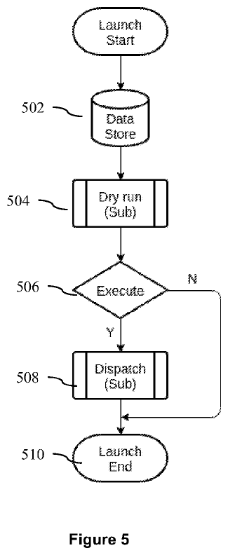

FIG. 5 shows a flowchart to launch a deployment file. In step 502, the deployment file is loaded from the database 116. In step 504, execution of the deployment file is simulated, to measure performance results of its specified layout of nodes to deploy an application. This simulation is undertaken because the current condition of the distributed network 108 may have changed compared to the conditions under which the deployment file was generated, with the possibility of the current condition having insufficient resources to support the imposed constraints of the deployment file from the step 502. If it is determined that the current condition of the distributed network 108 is unable to support the deployment file, the dispatcher module 121 will return warning messages. Step 510 then occurs if the user 104 chooses not to launch the deployment file.

Execution of the deployment file occurs in step 508, for example if acceptable performance results are returned from the simulation. The dispatcher module 121 will allow the federation engine 122 to execute the deployment file in accordance with its specified parameters. Should the user modify the deployment file while it is running or replace it with another deployment file, the federation engine 122 will perform the necessary differential updates.

FIG. 6 shows a flowchart that the platform 102 follows when maintaining operation of the deployment file.

The maintenance operation that starts at step 602 is a background process that runs without user intervention. At step 604, the recommender module 124 monitors the resource layers of the distributed network 108 for changes in available resources. If a change is detected, the recommender module 124 compares the changed layer with the deployed applications and generates one or more new deployment files that harness the changes. The recommender module 124 generates a new deployment file providing a layout for a new combination of identified nodes to deploy the application, wherein at least a portion of the identified nodes of the new combination include nodes made available by the change in the resources. In one implementation, the recommender module 124 determines an impact the change has on the deployment of the application under the existing deployment file before generating the new deployment file. In one approach, the new deployment file is generated if the change to the available resources results in deterioration in efficacy of the deployed application under the layout used by the existing deployment. The new combination of identified nodes includes nodes with operation parameters that exceed the imposed constraints compared to the identified nodes of the existing deployment file. In another approach, the new deployment file is generated if the new nodes provide lower cost per performance value.

With the new deployment file on hand, step 606 occurs where the recommender module 124 determines whether the user 104 has configured the platform 102 to automatically apply new deployment files that are generated from the active monitoring achieved by the flowchart of FIG. 6. Step 608 occurs if the user 104 has elected for automatic application, where the new deployment files are then output by the dispatcher module 121 and executed by the federation engine 122, with the new deployment files being saved into the database 116 in step 610. Otherwise step 612 occurs, where a notification is sent to prompt, with express consent required from the user 104 before replacing the existing deployment file with the new deployment file. Since the maintenance operation is always active, the end 614 of the flowchart of FIG. 6 will loop end back to its start 602. At step 604 of a new iteration, the recommender module 124 has the operation of rolling back the new deployment file (of the previous iteration) with an earlier deployment file, being part of the rolling updates and rollback feature described earlier with reference to FIG. 1.

FIGS. 2 to 6 show that input for the fields of the deployment file is received through: a graphic user interface (GUI, such as the geographic maps of FIGS. 3D and 3E) and an application programming interface (API, see step 304 of FIG. 3B). While not shown, the input can also be received from a command line interface (CLI).

FIG. 7 shows a schematic of the application 710 that the deployment file generated by the platform 102 of FIG. 1 seeks to deploy over the distributed network 108. The application 710 is configured to operate in any one or more of the following: a container environment 708, a bare metal environment 714 or a virtual machine environment 706.

As described earlier with reference to FIG. 1, the application 710 is bundled with a stack 702, 704, 716 of dependencies, such as necessary executables, binary code, runtime environment variables and libraries. The primary difference is that the application 710 bundled for operation in the container environment 708 provides a way to virtualise an OS (operation system) so that multiple workloads can run on a single OS instance. The platform 102 of FIG. 1 is configured to generate a deployment file that can be used in either of the container environment 708, the bare metal environment 714 or the virtual machine environment 706.

In the application, unless specified otherwise, the terms “comprising”, “comprise”, and grammatical variants thereof, intended to represent “open” or “inclusive” language such that they include recited elements but also permit inclusion of additional, non-explicitly recited elements. It will also be appreciated that the terms “information” and “data” are used interchangeably.

While this invention has been described with reference to exemplary embodiments, it will be understood by those skilled in the art that various changes can be made and equivalents may be substituted for elements thereof, without departing from the spirit and scope of the invention. In addition, modification may be made to adapt the teachings of the invention to particular situations and materials, without departing from the essential scope of the invention. Thus, the invention is not limited to the particular examples that are disclosed in this specification, but encompasses all embodiments falling within the scope of the appended claims.

1. A platform for creating a file specifying parameters required to deploy an application, the platform configured to:
receive input for fields present in a deployment file for an application, the input fields imposing constraints on a node where the application can be deployed;
interrogate a database storing information on nodes available to deploy the application;
identify, from the database, the nodes with operation parameters that comply with the imposed constraints;
display, through an interface, one or more layouts for selection, each layout providing a possible combination of the identified nodes to deploy the application; and
generate the deployment file based on the selected layout.

2. The platform of claim 1, further configured to formulate a search string, based on the imposed constraints, for interrogating the database.

3. The platform of claim 2, further configured to display a menu whose content comprises resource parameters that when selected become the input fields that impose the constraints on the node where the application can be deployed.

4. The platform of claim 3, wherein the resource parameters are organised by category, the resource parameters accessed through one or more of: a pull down list, a rollover list, a list contained in a pop-up window, or a list in a new window.

5. The platform of claim 4, wherein the categories are organised into hierarchical levels accessible according to sequence.

6. The platform of claim 5, further configured to
determine whether the selection of resource parameters has an impact on resource parameters available for subsequent selection; and
update the content of the menu to remove the resource parameters that have become unavailable for the subsequent selection.

7. The platform of claim 6, further configured to, after execution of the deployment file:
monitor for change in available resources;
generate a new deployment file providing a layout for a new combination of identified nodes to deploy the application, wherein at least a portion of the identified nodes of the new combination include nodes made available by the change in the resources.

8. The platform of claim 7, further configured to determine an impact the change has on the deployment of the application under the existing deployment file before generating the new deployment file.

9. The platform of claim 8, wherein the new deployment file is generated under any one or more of the following conditions: if the change to the available resources results in a deterioration in efficacy of the deployed application under the layout used by the existing deployment; or if the new combination of identified nodes provide lower cost per performance value.

10. The platform of claim 9, further configured to prompt before replacing the existing deployment file with the new deployment file.

11. The platform of claim 10, wherein the new combination of identified nodes includes nodes with operation parameters that exceed the imposed constraints compared to the identified nodes of the existing deployment file.

12. The platform of claim 11, further configured to roll back the new deployment file with an earlier deployment file.

13. The platform of claim 12, wherein the interface comprises a geographic map on which the one or more layouts for selection are superimposed.

14. The platform of claim 13, further configured to receive the selected layout through the geographic map.

15. The platform of claim 14, further configured to simulate execution of the deployment file for measuring performance results of the selected layout.

16. The platform of claim 15, further configured to execute the deployment file in response to acceptable performance results returned from the simulation.

17. The platform of claim 16, wherein the information in the database comprises any one or more of: physical location data, territorial borders, radio base station sites, military base locations, airport locations, heavy industrial locations, oil rig locations, energy turbine locations, local regulation requirement data, transport infrastructure data, population data, economic data and node service provider resource data.

18. The platform of claim 17, wherein the input for the fields of the deployment file is received through any one or more of a: graphic user interface (GUI), application programming interface (API) or a command line interface (CLI).

19. The platform of claim 18, wherein the application is configured to operate in any one or more of the following: a container environment, a bare metal environment or a virtual machine environment.
